(19) United States
(12) Patent Application Publication
(10) Pub. No.: US 2020/0102812 A1
(43) Pub. Date: Apr. 2, 2020

(54) ANALYZING PRODUCTIVITY INDICES DECLINE IN WELLS

(71) Applicant: Saudi Arabian Oil Company, Dhahran (SA)

(72) Inventors: Mohammed A. Alhuraifi, Al-Qatif (SA); Obiomalotaoso Leonard Isichei, Dhahran (SA); Mohammed H. Madan, Al-Qatif (SA); Muhammad A. Al-Hajri, Abqaiq (SA)

(73) Assignee: Saudi Arabian Oil Company, Dhahran (SA)

(21) Appl. No.: 16/145,669

(22) Filed: Sep. 28, 2018

(51) Int. Cl. E21B 41/00; G06F 17/50

(52) U.S. Cl. CPC E21B 41/0092; E21B 43/12; G06F 17/5009

(57) ABSTRACT

Calibrated network models for oil production systems are executed using a set of production metrics for a given well. An execution run is initially performed for the given well using a inputs corresponding to a specified time period. Multiple execution runs are performed, iterating on productivity index data for the specified time period, until a simulated production rate converges to a historical production rate corresponding. The productivity index value for the given well at the specified time period is determined based on the converged simulated production rate. The productivity index value represents the rate test conditions at the specified time period. The executing and determining are repeated for additional points in time for the given well to determine productivity index values representing the rate test conditions at respective ones of the additional points in time. A productivity index profile providing productivity index values as a function of time is generated.

### BACKGROUND

The present disclosure applies to techniques for analyzing productivity degradation in wells.

After an oil well has flowed for a significant time, its productivity tends to decline. Productivity index is a measure of the well capability to flow at a pressure drawdown. Over time, productivity in a well can decrease. Petroleum engineers can use information about oil well productivity to make decisions regarding improving performance of existing wells and potentially evaluate the best zones for drilling new wells in other locations of the reservoir.

### SUMMARY

The present disclosure describes techniques that can be used for analyzing the decline in productivity indices in wells (for example, oil or water wells). In some implementations, a computer-implemented method, includes: a computer-implemented method, comprising: executing, using a set of production metrics for a given well, a set of calibrated network models for oil production systems, including: initially performing an execution run for the given well using a set of inputs corresponding to a specified time period within a target production period; and performing multiple execution runs for the given well, iterating on productivity index data for the specified time period, until a simulated production rate converges to a historical production rate corresponding to a same set of rate test conditions; determining, based on the converged simulated production rate, the productivity index value for the given well at the specified time period, the productivity index value representing the rate test conditions at the specified time period; repeating the executing and determining for additional points in time within the specified time period for the given well to determine productivity index values representing the rate test conditions at respective ones of the additional points in time; and generating, for the given well and based on the determined productivity index values, a productivity index profile providing productivity index values as a function of time.

The previously described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, the accuracy of historical rate test data can be validated. Second, additional reservoir locations can be identified for drilling new wells. Third, candidates can be identified for stimulation jobs in oil production and water injection wells, and the candidates can be selected based on more than a limited pressure transient analysis. Therefore, candidates for stimulation can be identified with a great level of confidence. Fourth, underperforming oil and water wells can be identified by conducting a comprehensive review of historical production and reservoir data covering many years. Fifth, productivity indices can be estimated on all oil wells (including naturally-flowing and artificially-flowing) by utilizing previous production history and reservoir pressures. Sixth, benefits of the steady-state multi-phase simulator can be maximized through use by petroleum engineering to estimate the decline in productivity based on historical production or based on injection and reservoir pressure data. Seventh, a practical approach can be established to develop a profile for well productivity index versus time.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is flow diagram showing an example of a process for determining productivity index profiles for wells, according to some implementations of the present disclosure.

FIG. 2 is a flowchart of an example method for determining a productivity index profile providing productivity index values for a given well as a function of time, according to some implementations of the present disclosure.

FIG. 3 is a block diagram illustrating an example computer system used to provide computational functionalities associated with described algorithms, methods, functions, processes, flows, and procedures as described in the instant disclosure, according to some implementations of the present disclosure.

Like reference numbers and designations in the various drawings indicate like elements.

### DETAILED DESCRIPTION

The following detailed description describes techniques for determining a productivity index profile providing productivity index values for a given well as a function of time. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

In some implementations, hydraulic simulation software can be used to quantify the decline of productivity indices of oil production and water injection wells throughout a specified production period for the wells. The quantification can be done using a computer application that analyzes historical production or injection data and shut-in bottom-hole pressure data for the wells.

Optimization of oil and water wells can be achieved by estimating the decline of a productivity index based on historical production and reservoir data. The estimate in the decline of the productivity index can be used to forecast the contribution of oil wells in the future and to estimate stimulation requirements for boosting the performance of wells.

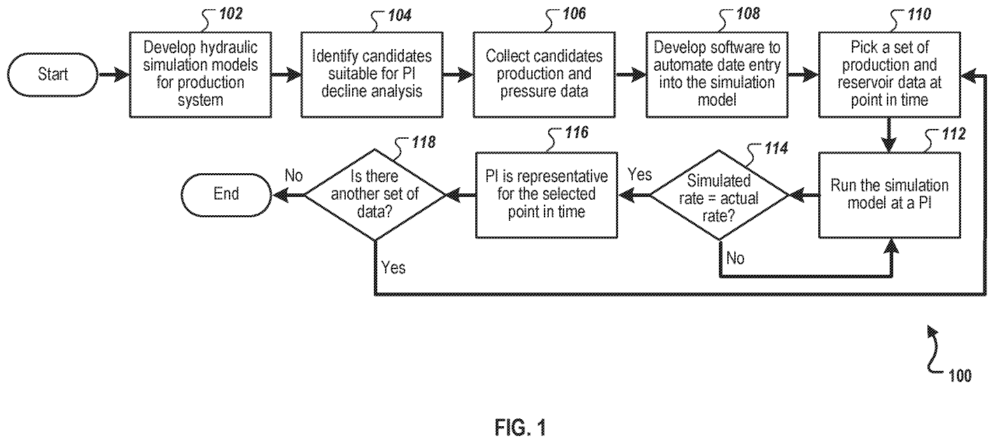

FIG. 1 is flow diagram showing an example of a process 100 for determining productivity index profiles for wells, according to some implementations of the present disclosure. The process 100 can be used, for example, to calculate historical productivity indexes for wells by using historical data and an advanced physics model. In some implementations, various steps of process 100 can be run in parallel, in combination, in loops, or in any order.

At 102, calibrated network models for oil production systems are developed using a steady-state multiphase flow simulation software. For example, available multi-phase flow simulators can be used to model oil production using a wide variety of industry-standard multiphase flow correlations.

At 104, potential well candidates are automatically identified that are suitable for determining productivity decline. The potential well candidates can include wells that have been at the same completion during a production period that is desired for analysis. For example, petroleum engineers can identify oil wells that have been in operation for some time but may have undergone decreases in production for which the petroleum engineers may want to perform a productivity analysis.

At 106, historical production data and corresponding shut-in bottom hole reservoir pressure data are automatically gathered. The historical production data can include, for example, production rates, gas-oil ratios, water cut conditions, flowing wellhead pressures, and choke settings. The information that is automatically gathered shall pertain to the production period desired that is for analysis. For example, information about operations at oil wells can be collected over time, including productivity output that is correlated to pressures that are detected during production. The information can be correlated such that historical information for similar wells can be compared where similar oil operations exist based on oil well location, geology, and oil production techniques used at various wells.

At 108, an application (for example, a Python script) can be used to automatically feed date-specific historical data related to the rate test conditions into the developed simulation model. As an example, scripts can be developed and used to read the historical information representing various points in time and automatically feed the pertinent portions of the historical information into the used multi-phase simulation models.

At 110, a set of production and reservoir data at a point in time is selected. Petroleum engineers can select, for example, a particular period in time for which analysis is to be performed on productivity indices, including declines in the productivity indices.

At 112, the used multi-phase flow simulator is run. For example, the application can initiate execution of the calibrated network models using one set of data at a particular point of time that is within the production period. As an example, the application can invoke the calibrated network models, for example, using parameters that cause the particular time periods to be analyzed.

At 114, a determination is made whether the simulated production rate matches the actual production rate. If not, then the simulation models can undergo multiple execution runs at 112 (regressing on productivity index data) until a simulated production rate matches a historical production rate corresponding to the same set of rate test conditions. For example, after each execution the models, the application can look for a match between the output of the simulation models and the data for the well being analyzed. Execution of the simulation models can be repeated until the data of the model converges on the data of the well being analyzed.

At 116, a productivity index is selected that matches production rate, where the productivity index is representative of the subject rate test conditions. For example, based on a point at which the data of the model has converged on the data of the well being analyzed, a productivity index for the well being analyzed can be selected for the point in time being analyzed.

At 118, a determination is made whether the calibrated network models need to be run for another set of data. If so, then the application can select another set of rate test conditions, repeating step 110 and subsequent steps to find another productivity index value which is corresponding to another time. For example, the application can cause execution of the simulation models for a next point in time an incremental time period.

The completion of process 100 can result in a determination of a profile that defines productivity index values as a function of time. As an example, the application can aggregate all of the productivity indices determined over time for the well being analyzed in order to generate a productivity index profile for the well being analyzed.

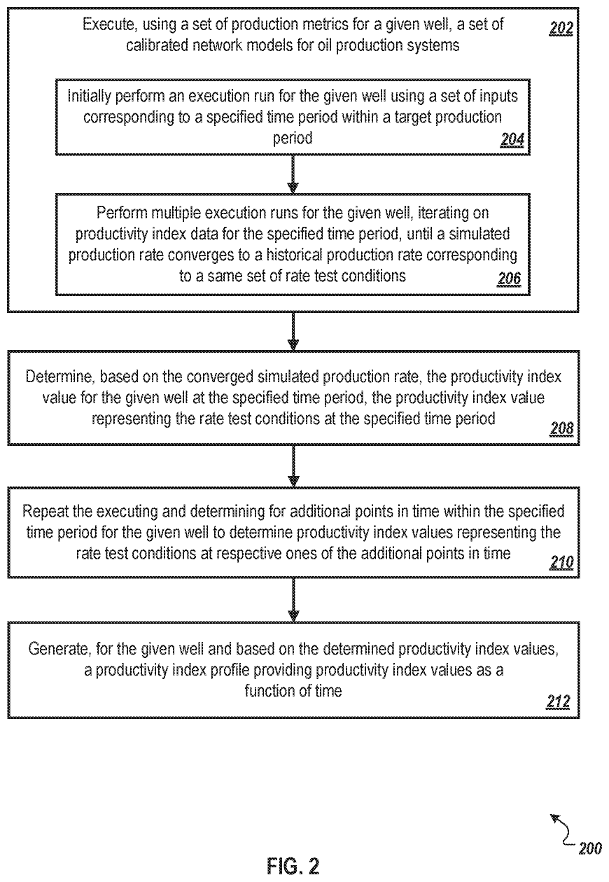

FIG. 2 is a flowchart of an example method 200 for determining a productivity index profile providing productivity index values for a given well as a function of time, according to some implementations of the present disclosure. For clarity of presentation, the description that follows generally describes method 200 in the context of the other figures in this description. However, it will be understood that method 200 can be performed, for example, by any suitable system, environment, software, and hardware, or a combination of systems, environments, software, and hardware, as appropriate. In some implementations, various steps of method 200 can be run in parallel, in combination, in loops, or in any order.

At 202, calibrated network models for oil production systems are executed using a set of production metrics for a given well (for example, Well#7). The set of production metrics can include, for example, historical production data and shut-in bottom hole reservoir pressure data. The historical production data can include, for example, production rates, gas-oil ratios, water cut conditions, flowing wellhead pressures, and choke settings. The calibrated network models can model, for example, components of production such as the wellhead and the flow line. The calibrated network models can be used, for example, to optimize production, improve decision making, and plan for additional well drilling activities. In some implementations, executing the calibrated network models includes steps 204 and 206.

At 204, an execution run is initially performed for the given well using a set of inputs corresponding to a specified time period within a target production period. For example, a target production period can be selected to be a time period that includes a specific sequence of N days for which petroleum engineers wish to obtain information regarding productivity index values for Well#7. The first execution run of the calibrated network models can use information for a specified time period, such as Day 1 of a sequence of Days 1 to N. From 204, method 200 proceeds to 206.

At 206, multiple execution runs are performed for the given well, iterating on productivity index data for the specified time period, until a simulated production rate converges to a historical production rate corresponding to a same set of rate test conditions. Each iteration can be used, for example, to compare data for Well#7 for the specified time period (for example, Day 1) to historical information that includes productivity index information gathered over time for other wells having similar conditions as Well#7. From 206, method 200 proceeds to 208.

In some implementations, method 200 can include steps that are performed before step 202 (and contained steps 204 and 206). First, the set of calibrated network models can be pre-generated using a steady-state multiphase flow simulation. Next, wells that are potential candidates suitable for the generation of productivity index values can be identified. For example, wells that are potential candidates can include wells that have been at a same completion stage during the target production period and that have a productivity decline. In another example, petroleum engineers can select specific wells that are to be checked for productivity based on various criteria including the age of the wells, their past and current production rates, and their overall importance. The set of production metrics for the wells and the set of production metrics corresponding to a target production period to be analyzed can be received and provided for use by the set of calibrated network models. In some implementations, providing the production metrics for use by the set of calibrated network models can include automating entry of date-specific production metrics into the set of calibrated network models.

At 208, the productivity index value for the given well at the specified time period is determined based on the converged simulated production rate. The productivity index value represents the rate test conditions at the specified time period. In this example, the converged simulated production rate from the last of the multiple execution runs can be used to determine the productivity index value for Day 1 for Well#7. From 208, method 200 proceeds to 210.

At 210, the executing and determining are repeated for additional points in time within the specified time period for the given well to determine productivity index values representing the rate test conditions at respective ones of the additional points in time. As an example, each execution run after the first execution run of the calibrated network models can use information for each of the remaining Days 2 through N of production at Well#7. From 210, method 200 proceeds to 212.

At 212, a productivity index profile that provides productivity index values as a function of time is generated for the given well based on the determined productivity index values. As an example, the productivity index profile for Well#7 can be used to inquire about productivity for a day or productivity changes over time. In another example, tools that access information in the productivity index profile for Well#7 can be used to identify points in time when significant declines in productivity occur. After 212, method 200 stops.

In some implementations, productivity index profiles can have different divisions of time other than days. For example, productivity index profiles can include information that provides divisions of intervals ranging from several days to many years. Productivity index profiles of groups of different wells can be compared to determine, for example, trends among wells or to identify productivity differences for wells in different regions.

In some implementations, method 200 can further include identifying reservoir locations to drill new wells, the identifying based on comparing productivity index profiles of multiple wells. For example, petroleum engineer can use the productivity index profiles for one or more wells to make decisions to drill new wells in a same area or in a different area.

In some implementations, method 200 can further include validating the accuracy of historical rate test data. For example, using the productivity index profiles, the accuracy of the rate test data available in the database can be improved.

In some implementations, method 200 can further include identifying additional reservoir locations at which new wells can be drilled. The locations can be selected, for example, based on a thorough analysis of the existing wells' performance and can include an evaluation of the productivity index profiles of existing wells in locations being considered for new drilling.

In some implementations, method 200 can further include identifying candidates for stimulation jobs in oil production and water injection wells. For example, the productivity index profile of the well can be used with, or in addition to, pressure transient analysis in order to identify opportunities for stimulation in order to boost the production in the well.

In some implementations, method 200 can further include identifying underperforming oil and water wells by conducting a comprehensive review for historical production and reservoir data for which many years of information are available in a database. For example, this approach can use productivity index profiles to help identify, with a greater level of confidence, candidates for stimulation.

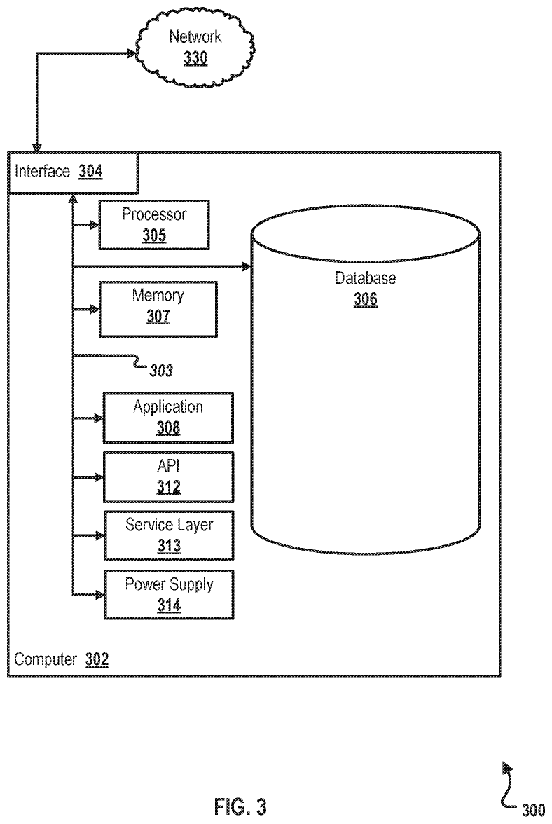

FIG. 3 is a block diagram of an example computer system 300 used to provide computational functionalities associated with described algorithms, methods, functions, processes, flows, and procedures, as described in the instant disclosure, according to some implementations of the present disclosure. The illustrated computer 302 is intended to encompass any computing device such as a server, desktop computer, laptop/notebook computer, wireless data port, smart phone, personal data assistant (PDA), tablet computing device, one or more processors within these devices, or any other suitable processing device, including physical or virtual instances (or both) of the computing device. Additionally, the computer 302 may comprise a computer that includes an input device, such as a keypad, keyboard, touch screen, or other device that can accept user information, and an output device that conveys information associated with the operation of the computer 302, including digital data, visual, or audio information (or a combination of information), or a graphical-type user interface (UI) (or GUI).

The computer 302 can serve in a role as a client, network component, a server, a database or other persistency, or any other component (or a combination of roles) of a computer system for performing the subject matter described in the instant disclosure. The illustrated computer 302 is communicably coupled with a network 330. In some implementations, one or more components of the computer 302 may be configured to operate within environments, including cloud-computing-based, local, global, or other environment (or a combination of environments).

At a high level, the computer 302 is an electronic computing device operable to receive, transmit, process, store, or manage data and information associated with the described subject matter. According to some implementations, the computer 302 may also include or be communicably coupled with an application server, email server, web server, caching server, streaming data server, or other server (or a combination of servers).

The computer 302 can receive requests over network 330 from a client application (for example, executing on another computer 302) and respond to the received requests by processing the received requests using an appropriate software application(s). In addition, requests may also be sent to the computer 302 from internal users (for example, from a command console or by other appropriate access method), external or third-parties, other automated applications, as well as any other appropriate entities, individuals, systems, or computers.

Each of the components of the computer 302 can communicate using a system bus 303. In some implementations, any or all of the components of the computer 302, hardware or software (or a combination of both hardware and software), may interface with each other or the interface 304 (or a combination of both), over the system bus 303 using an application programming interface (API) 312 or a service layer 313 (or a combination of the API 312 and service layer 313). The API 312 may include specifications for routines, data structures, and object classes. The API 312 may be either computer-language independent or dependent and refer to a complete interface, a single function, or even a set of APIs. The service layer 313 provides software services to the computer 302 or other components (whether or not illustrated) that are communicably coupled to the computer 302. The functionality of the computer 302 may be accessible for all service consumers using this service layer. Software services, such as those provided by the service layer 313, provide reusable, defined functionalities through a defined interface. For example, the interface may be software written in JAVA, C++, or other suitable language providing data in extensible markup language (XML) format or other suitable format. While illustrated as an integrated component of the computer 302, alternative implementations may illustrate the API 312 or the service layer 313 as stand-alone components in relation to other components of the computer 302 or other components (whether or not illustrated) that are communicably coupled to the computer 302. Moreover, any or all parts of the API 312 or the service layer 313 may be implemented as child or sub-modules of another software module, enterprise application, or hardware module without departing from the scope of this disclosure.

The computer 302 includes an interface 304. Although illustrated as a single interface 304 in FIG. 3, two or more interfaces 304 may be used according to particular needs, desires, or particular implementations of the computer 302. The interface 304 is used by the computer 302 for communicating with other systems that are connected to the network 330 (whether illustrated or not) in a distributed environment. Generally, the interface 304 comprises logic encoded in software or hardware (or a combination of software and hardware) and is operable to communicate with the network 330. More specifically, the interface 304 may comprise software supporting one or more communication protocols associated with communications such that the network 330 or interface's hardware is operable to communicate physical signals within and outside of the illustrated computer 302.

The computer 302 includes a processor 305. Although illustrated as a single processor 305 in FIG. 3, two or more processors may be used according to particular needs, desires, or particular implementations of the computer 302. Generally, the processor 305 executes instructions and manipulates data to perform the operations of the computer 302 and any algorithms, methods, functions, processes, flows, and procedures as described in the instant disclosure.

The computer 302 also includes a database 306 that can hold data for the computer 302 or other components (or a combination of both) that can be connected to the network 330 (whether illustrated or not). For example, database 306 can be an in-memory, conventional, or other type of database storing data consistent with this disclosure. In some implementations, database 306 can be a combination of two or more different database types (for example, a hybrid in-memory and conventional database) according to particular needs, desires, or particular implementations of the computer 302 and the described functionality. Although illustrated as a single database 306 in FIG. 3, two or more databases (of the same or combination of types) can be used according to particular needs, desires, or particular implementations of the computer 302 and the described functionality. While database 306 is illustrated as an integral component of the computer 302, in alternative implementations, database 306 can be external to the computer 302.

The computer 302 also includes a memory 307 that can hold data for the computer 302 or other components (or a combination of both) that can be connected to the network 330 (whether illustrated or not). Memory 307 can store any data consistent with this disclosure. In some implementations, memory 307 can be a combination of two or more different types of memory (for example, a combination of semiconductor and magnetic storage) according to particular needs, desires, or particular implementations of the computer 302 and the described functionality. Although illustrated as a single memory 307 in FIG. 3, two or more memories 307 (of the same or combination of types) can be used according to particular needs, desires, or particular implementations of the computer 302 and the described functionality. While memory 307 is illustrated as an integral component of the computer 302, in alternative implementations, memory 307 can be external to the computer 302.

The application 308 is an algorithmic software engine providing functionality according to particular needs, desires, or particular implementations of the computer 302, particularly with respect to functionality described in this disclosure. For example, application 308 can serve as one or more components, modules, or applications. Further, although illustrated as a single application 308, the application 308 may be implemented as multiple applications 308 on the computer 302. In addition, although illustrated as integral to the computer 302, in alternative implementations, the application 308 can be external to the computer 302.

The computer 302 can also include a power supply 314. The power supply 314 can include a rechargeable or non-rechargeable battery that can be configured to be either user- or non-user-replaceable. In some implementations, the power supply 314 can include power-conversion or management circuits (including recharging, standby, or other power management functionality). In some implementations, the power-supply 314 can include a power plug to allow the computer 302 to be plugged into a wall socket or other power source to, for example, power the computer 302 or recharge a rechargeable battery.

There may be any number of computers 302 associated with, or external to, a computer system containing computer 302, each computer 302 communicating over network 330. Further, the term “client,” “user,” and other appropriate terminology may be used interchangeably, as appropriate, without departing from the scope of this disclosure. Moreover, this disclosure contemplates that many users may use one computer 302, or that one user may use multiple computers 302.

Described implementations of the subject matter can include one or more features, alone or in combination.

For example, in a first implementation, a computer-implemented method, comprising: executing, using a set of production metrics for a given well, a set of calibrated network models for oil production systems, including: initially performing an execution run for the given well using a set of inputs corresponding to a specified time period within a target production period; and performing multiple execution runs for the given well, iterating on productivity index data for the specified time period, until a simulated production rate converges to a historical production rate corresponding to a same set of rate test conditions; determining, based on the converged simulated production rate, the productivity index value for the given well at the specified time period, the productivity index value representing the rate test conditions at the specified time period; repeating the executing and determining for additional points in time within the specified time period for the given well to determine productivity index values representing the rate test conditions at respective ones of the additional points in time; and generating, for the given well and based on the determined productivity index values, a productivity index profile providing productivity index values as a function of time.

The foregoing and other described implementations can each, optionally, include one or more of the following features:

A first feature, combinable with any of the following features, the method further comprising: generating, using a steady-state multiphase flow simulation, the set of calibrated network models; identifying wells that are potential candidates suitable for an application of productivity index values; receiving the set of production metrics for the wells, the set of production metrics corresponding to a target production period to be analyzed; and providing the set of production metrics for use by the set of calibrated network models.

A second feature, combinable with any of the previous or following features, wherein the set of production metrics include historical production data and shut-in bottom hole reservoir pressure data.

A third feature, combinable with any of the previous or following features, wherein the steady-state multiphase flow simulation uses a hydraulic simulation software.

A fourth feature, combinable with any of the previous or following features, wherein identifying the wells that are potential well candidates includes identifying wells that have been at a same completion stage during the target production period and that have a productivity decline.

A fifth feature, combinable with any of the previous or following features, the method further comprising wherein the historical production data includes production rates, gas-oil ratios, water cut conditions, flowing wellhead pressures, and choke settings.

A sixth feature, combinable with any of the previous or following features, wherein providing the production metrics for use by the set of calibrated network models includes automating entry of date-specific production metrics into the set of calibrated network models.

An eighth feature, combinable with any of the previous or following features, further comprising identifying reservoir locations to drill new wells, the identifying based on comparing productivity index profiles of multiple wells.

In a second implementation, a non-transitory, computer-readable medium storing one or more instructions executable by a computer system to perform operations comprising: executing, using a set of production metrics for a given well, a set of calibrated network models for oil production systems, including: initially performing an execution run for the given well using a set of inputs corresponding to a specified time period within a target production period; and performing multiple execution runs for the given well, iterating on productivity index data for the specified time period, until a simulated production rate converges to a historical production rate corresponding to a same set of rate test conditions; determining, based on the converged simulated production rate, the productivity index value for the given well at the specified time period, the productivity index value representing the rate test conditions at the specified time period; repeating the executing and determining for additional points in time within the specified time period for the given well to determine productivity index values representing the rate test conditions at respective ones of the additional points in time; and generating, for the given well and based on the determined productivity index values, a productivity index profile providing productivity index values as a function of time.

The foregoing and other described implementations can each, optionally, include one or more of the following features:

A first feature, combinable with any of the following features, the operations further comprising: generating, using a steady-state multiphase flow simulation, the set of calibrated network models; identifying wells that are potential candidates suitable for an application of productivity index values; receiving the set of production metrics for the wells, the set of production metrics corresponding to a target production period to be analyzed; and providing the set of production metrics for use by the set of calibrated network models.

A second feature, combinable with any of the previous or following features, wherein the set of production metrics include historical production data and shut-in bottom hole reservoir pressure data.

A third feature, combinable with any of the previous or following features, wherein the steady-state multiphase flow simulation uses a hydraulic simulation software.

A fourth feature, combinable with any of the previous or following features, wherein identifying the wells that are potential well candidates includes identifying wells that have been at a same completion stage during the target production period and that have a productivity decline.

A fifth feature, combinable with any of the previous or following features, the operations further comprising wherein the historical production data includes production rates, gas-oil ratios, water cut conditions, flowing wellhead pressures, and choke settings.

In a third implementation, a computer-implemented system, comprising: one or more processors; and a non-transitory computer-readable storage medium coupled to the one or more processors and storing programming instructions for execution by the one or more processors, the programming instructions instruct the one or more processors to perform operations comprising: executing, using a set of production metrics for a given well, a set of calibrated network models for oil production systems, including: initially performing an execution run for the given well using a set of inputs corresponding to a specified time period within a target production period; and performing multiple execution runs for the given well, iterating on productivity index data for the specified time period, until a simulated production rate converges to a historical production rate corresponding to a same set of rate test conditions; determining, based on the converged simulated production rate, the productivity index value for the given well at the specified time period, the productivity index value representing the rate test conditions at the specified time period; repeating the executing and determining for additional points in time within the specified time period for the given well to determine productivity index values representing the rate test conditions at respective ones of the additional points in time; and generating, for the given well and based on the determined productivity index values, a productivity index profile providing productivity index values as a function of time.

The foregoing and other described implementations can each, optionally, include one or more of the following features:

A first feature, combinable with any of the following features, the operations further comprising: generating, using a steady-state multiphase flow simulation, the set of calibrated network models; identifying wells that are potential candidates suitable for an application of productivity index values; receiving the set of production metrics for the wells, the set of production metrics corresponding to a target production period to be analyzed; and providing the set of production metrics for use by the set of calibrated network models.

A second feature, combinable with any of the previous or following features, wherein the set of production metrics include historical production data and shut-in bottom hole reservoir pressure data.

A third feature, combinable with any of the previous or following features, wherein the steady-state multiphase flow simulation uses a hydraulic simulation software.

A fourth feature, combinable with any of the previous or following features, wherein identifying the wells that are potential well candidates includes identifying wells that have been at a same completion stage during the target production period and that have a productivity decline.

A fifth feature, combinable with any of the previous or following features, the operations further comprising wherein the historical production data includes production rates, gas-oil ratios, water cut conditions, flowing wellhead pressures, and choke settings.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data includes all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/−R, DVD-RAM, DVD-ROM, HD-DVD, and BLURAY, and other optical memory technologies. The memory may store various objects or data, including caches, classes, frameworks, applications, modules, backup data, jobs, web pages, web page templates, data structures, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a cathode ray tube (CRT), liquid crystal display (LCD), light-emitting diode (LED), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with some implementations of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

Cluster file system involved in this invention can be any file system type accessible from multiple servers for read and update. Locking or consistency tracking is not necessary in this invention since the locking of exchange file system can be done at application layer. Furthermore, Unicode data files are different from non-Unicode data files.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
executing, using a set of production metrics for a given well, a set of calibrated network models for oil production systems, including:
initially performing an execution run for the given well using a set of inputs corresponding to a specified time period within a target production period; and
performing multiple execution runs for the given well, iterating on productivity index data for the specified time period, until a simulated production rate converges to a historical production rate corresponding to a same set of rate test conditions;
determining, based on the converged simulated production rate, the productivity index value for the given well at the specified time period, the productivity index value representing the rate test conditions at the specified time period;
repeating the executing and determining for additional points in time within the specified time period for the given well to determine productivity index values representing the rate test conditions at respective ones of the additional points in time; and
generating, for the given well and based on the determined productivity index values, a productivity index profile providing productivity index values as a function of time.

2. The computer-implemented method of claim 1, further comprising:
generating, using a steady-state multiphase flow simulation, the set of calibrated network models;
identifying wells that are potential candidates suitable for an application of productivity index values;
receiving the set of production metrics for the wells, the set of production metrics corresponding to a target production period to be analyzed; and
providing the set of production metrics for use by the set of calibrated network models.

3. The computer-implemented method of claim 1, wherein the set of production metrics include historical production data and shut-in bottom hole reservoir pressure data.

4. The computer-implemented method of claim 2, wherein the steady-state multiphase flow simulation uses a hydraulic simulation software.

5. The computer-implemented method of claim 1, wherein identifying the wells that are potential well candidates includes identifying wells that have been at a same completion stage during the target production period and that have a productivity decline.

6. The computer-implemented method of claim 3, wherein the historical production data includes production rates, gas-oil ratios, water cut conditions, flowing wellhead pressures, and choke settings.

7. The computer-implemented method of claim 1, wherein providing the production metrics for use by the set of calibrated network models includes automating entry of date-specific production metrics into the set of calibrated network models.

8. The computer-implemented method of claim 1, further comprising identifying reservoir locations to drill new wells, the identifying based on comparing productivity index profiles of multiple wells

9. A non-transitory, computer-readable medium storing one or more instructions executable by a computer system to perform operations comprising:
executing, using a set of production metrics for a given well, a set of calibrated network models for oil production systems, including:
initially performing an execution run for the given well using a set of inputs corresponding to a specified time period within a target production period; and
performing multiple execution runs for the given well, iterating on productivity index data for the specified time period, until a simulated production rate converges to a historical production rate corresponding to a same set of rate test conditions;
determining, based on the converged simulated production rate, the productivity index value for the given well at the specified time period, the productivity index value representing the rate test conditions at the specified time period;
repeating the executing and determining for additional points in time within the specified time period for the given well to determine productivity index values representing the rate test conditions at respective ones of the additional points in time; and
generating, for the given well and based on the determined productivity index values, a productivity index profile providing productivity index values as a function of time.

10. The non-transitory, computer-readable medium of claim 9, the operations further comprising:
generating, using a steady-state multiphase flow simulation, the set of calibrated network models;
identifying wells that are potential candidates suitable for an application of productivity index values;
receiving the set of production metrics for the wells, the set of production metrics corresponding to a target production period to be analyzed; and
providing the set of production metrics for use by the set of calibrated network models.

11. The non-transitory, computer-readable medium of claim 9, wherein the set of production metrics include historical production data and shut-in bottom hole reservoir pressure data.

12. The non-transitory, computer-readable medium of claim 10, wherein the steady-state multiphase flow simulation uses a hydraulic simulation software.

13. The non-transitory, computer-readable medium of claim 9, wherein identifying the wells that are potential well candidates includes identifying wells that have been at a same completion stage during the target production period and that have a productivity decline.

14. The non-transitory, computer-readable medium of claim 11, wherein the historical production data includes production rates, gas-oil ratios, water cut conditions, flowing wellhead pressures, and choke settings.

15. A computer-implemented system, comprising:
one or more processors; and
a non-transitory computer-readable storage medium coupled to the one or more processors and storing programming instructions for execution by the one or more processors, the programming instructions instruct the one or more processors to perform operations comprising:
executing, using a set of production metrics for a given well, a set of calibrated network models for oil production systems, including:
initially performing an execution run for the given well using a set of inputs corresponding to a specified time period within a target production period; and
performing multiple execution runs for the given well, iterating on productivity index data for the specified time period, until a simulated production rate converges to a historical production rate corresponding to a same set of rate test conditions;
determining, based on the converged simulated production rate, the productivity index value for the given well at the specified time period, the productivity index value representing the rate test conditions at the specified time period;
repeating the executing and determining for additional points in time within the specified time period for the given well to determine productivity index values representing the rate test conditions at respective ones of the additional points in time; and
generating, for the given well and based on the determined productivity index values, a productivity index profile providing productivity index values as a function of time.

16. The computer-implemented system of claim 15, the operations further comprising:
generating, using a steady-state multiphase flow simulation, the set of calibrated network models;
identifying wells that are potential candidates suitable for an application of productivity index values;
receiving the set of production metrics for the wells, the set of production metrics corresponding to a target production period to be analyzed; and
providing the set of production metrics for use by the set of calibrated network models.

17. The computer-implemented system of claim 15, wherein the set of production metrics include historical production data and shut-in bottom hole reservoir pressure data.

18. The computer-implemented system of claim 16, wherein the steady-state multiphase flow simulation uses a hydraulic simulation software.

19. The computer-implemented system of claim 15, wherein identifying the wells that are potential well candidates includes identifying wells that have been at a same completion stage during the target production period and that have a productivity decline.

20. The computer-implemented system of claim 17, wherein the historical production data includes production rates, gas-oil ratios, water cut conditions, flowing wellhead pressures, and choke settings.
